(19) United States
(12) Patent Application Publication
(10) Pub. No.: US 2026/0097820 A1
(43) Pub. Date: Apr. 9, 2026

(54) MODULAR TRAILER AND EFFICIENCY-MAXIMIZING TRAILER MANUFACTURING PROCESS

(71) Applicant: Hunter Schultheis, Longmont, CO (US)

(72) Inventor: Hunter Schultheis, Longmont, CO (US)

(73) Assignee: Hunter Schultheis, Longmont, CO (US)

(21) Appl. No.: 19/350,114

(22) Filed: Oct. 6, 2025

Related U.S. Application Data
(60) Provisional application No. 63/703,617, filed on Oct. 4, 2024.

(51) Int. Cl. B62D 63/08; B21D 5/00; B23K 26/38; B62D 29/00; B62D 33/02; B62D 33/077

(52) U.S. Cl. CPC B62D 63/08; B21D 5/004; B23K 26/38; B62D 29/007; B62D 33/0222; B62D 33/077

(57) ABSTRACT

An vehicular tow-behind trailer design and manufacturing process primarily utilizing 4′ by 8′ sheets of 11 gauge cold rolled steel as the primary input material. The process employs a nitrogen laser cutter and CNC press brake to create precisely engineered components, resulting in a modular, lightweight trailer that is easier to manufacture and assemble. The design features two distinct models sharing common components, with variations in size and configuration to meet diverse user needs. Key innovations include a removable roof, pre-cut attachment points for accessories, and a modular frame design with a removable tongue for efficient shipping.

### CROSS REFERENCE TO RELATED APPLICATIONS

This application claims the benefit of priority to U.S. Provisional Ser. No. 63/703,617, filed on Oct. 4, 2024, the contents of which are hereby incorporated by reference in its entirety.

### BACKGROUND OF THE INVENTION

Vehicular tow-behind trailers are widely used for transporting goods, equipment, and materials. However, traditional trailer designs face several challenges that limit their effectiveness and ease of use.

One significant problem with existing trailer designs is their weight. Many trailers utilize square steel tubing as the primary material for constructing the main body. While steel tubing provides structural strength, it contributes substantially to the overall weight of the trailer. This excessive weight can negatively impact fuel efficiency, reduce the effective payload capacity, and make the trailer more difficult to maneuver.

Another major issue lies in the difficulty of assembly for traditional trailer designs. The use of square steel tubing presents several complications. Construction complexity is a primary concern, as building a box-like structure for the main body of the trailer using square steel tubing is a challenging process. It often requires specialized skills and equipment, making it difficult for individuals or small-scale manufacturers to produce trailers efficiently.

The assembly of steel tubing components typically relies on welding or other complex joining techniques. These methods require specific expertise and equipment, further complicating the manufacturing process. The use of square tubing also demands high precision in cutting and fitting. Each subcomponent must be exactly cut to match the existing trailer design, which increases the time and effort required for construction.

The manufacturing process for trailers using square steel tubing often requires exorbitant fabrication equipment. This high capital investment can be a barrier to entry for smaller manufacturers or individuals looking to produce trailers. Additionally, the intricate nature of working with steel tubing, combined with the need for precise cutting and welding of individual subcomponents, results in a time-consuming manufacturing process that demands considerable expertise.

These challenges in design and construction contribute to higher production costs, longer manufacturing times, and limited customization options for tow-behind trailers. There is a clear need for innovative trailer designs that address these issues, particularly focusing on reducing weight, simplifying assembly processes, and minimizing the specialized equipment and expertise required for manufacturing.

### SUMMARY OF THE INVENTION

Embodiments of the invention relate to an innovative design and manufacturing process for vehicular tow-behind trailers. This embodiment addresses several key challenges in traditional trailer construction by utilizing a novel approach that emphasizes simplicity, efficiency, and precision in manufacturing.

At the core of embodiments is the primary use of 4 foot by 8 foot pieces of cold rolled steel as the primary input material for trailer construction. This standardized input allows for a more streamlined and efficient manufacturing process compared to traditional methods that rely heavily on square steel tubing.

The trailer design of an embodiment benefits from precisely engineered components made from 11 gauge rolled steel. These components are crafted using advanced manufacturing techniques, specifically a nitrogen laser cutter and a Computer Numerical Control (CNC) press brake. This combination of standardized input material and precision manufacturing equipment allows for the creation of highly accurate and consistent trailer components.

One of the key innovations of this embodiment is the ability to create most, if not all, components of the trailer (primarily excluding connectors such as bolts, nuts, and washers) from the same 4′ by 8′ 11 gauge cold rolled steel sheets. This general uniformity in material input dramatically simplifies the manufacturing process and results in precisely engineered output components that significantly ease the assembly process.

The manufacturing process in accordance with an embodiment begins with the use of a nitrogen laser cutter, which can achieve tolerances as precise as 3 thousandths of an inch. This laser cutter is used to cut the 4′ by 8′ steel sheets into the required shapes for various trailer components. The laser cutter also creates precise holes in these components, which serve as attachment points for accessories such as molly panels, fenders, racks, and roof towers.

Following the laser cutting process, a CNC press brake is used to bend the cut steel sheets into the required shapes. The press brake is programmed to perform specific bends, ensuring consistency and precision in the shaping of each component. This process allows for the creation of complex shapes and structures that would be difficult or impossible to achieve with traditional manufacturing methods.

This innovative approach to trailer design and manufacturing results in a product that is easier to manufacture, lighter in weight, and quicker to assemble compared to traditional trailer designs. This embodiment represents a shift from fabricated design to engineered design, leveraging computer-aided design (CAD) and precision manufacturing equipment to create a more efficient and cost-effective product.

Embodiments of the invention include two distinct trailer models that share many common components and manufacturing processes while differing in size and configuration to meet varying user needs. The larger model features increased length and height, with a dual rear door configuration. The lower rear door is designed with a downward slope towards the anterior of the trailer, providing an improved departure angle for off-road use. The smaller model offers a more compact design, likely with a single rear door configuration.

Both models incorporate innovative features such as removable roofs for customization, pre-cut holes and attachment points for accessories, and a modular frame design that includes a removable tongue for improved shipping efficiency. The shared components and manufacturing processes between the two models contribute to manufacturing efficiency and cost-effectiveness, while the differences in size and configuration allow the invention to cater to a broader range of user needs and applications.

In summary, embodiments of the invention present a novel approach to trailer design and manufacturing that addresses key challenges in traditional trailer construction. By leveraging standardized materials, precision manufacturing techniques, and modular design principles, these embodiments offer a more efficient, cost-effective, and versatile solution for vehicular tow-behind trailers.

### BRIEF DESCRIPTION OF THE FIGURES

FIG. 1 depicts an exploded view of an embodiment of the trailer showing various components.

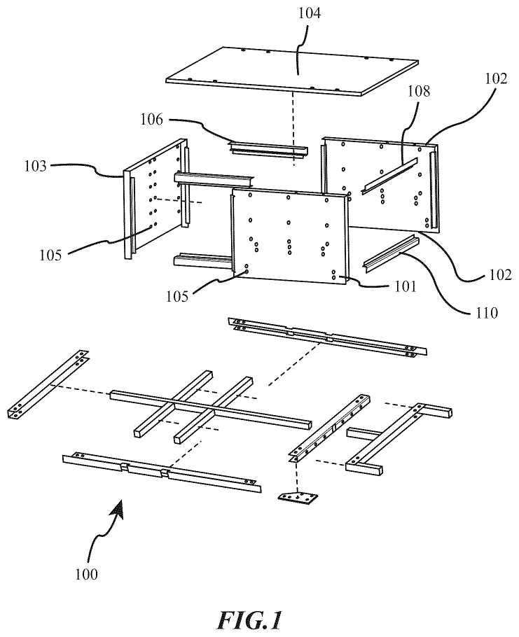

FIG. 2 depicts a perspective view of an embodiment of the partially assembled trailer.

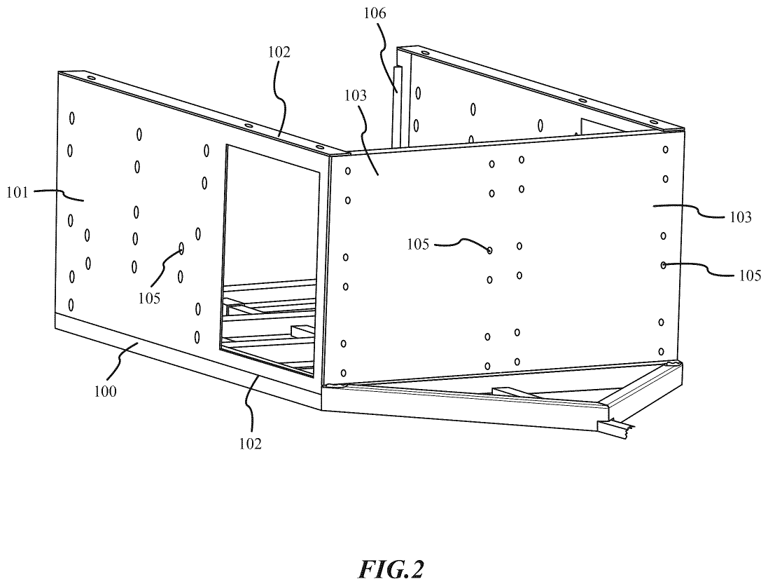

FIG. 3 depicts a perspective view of an embodiment of the partially assembled trailer showing the placement of the detachable roof.

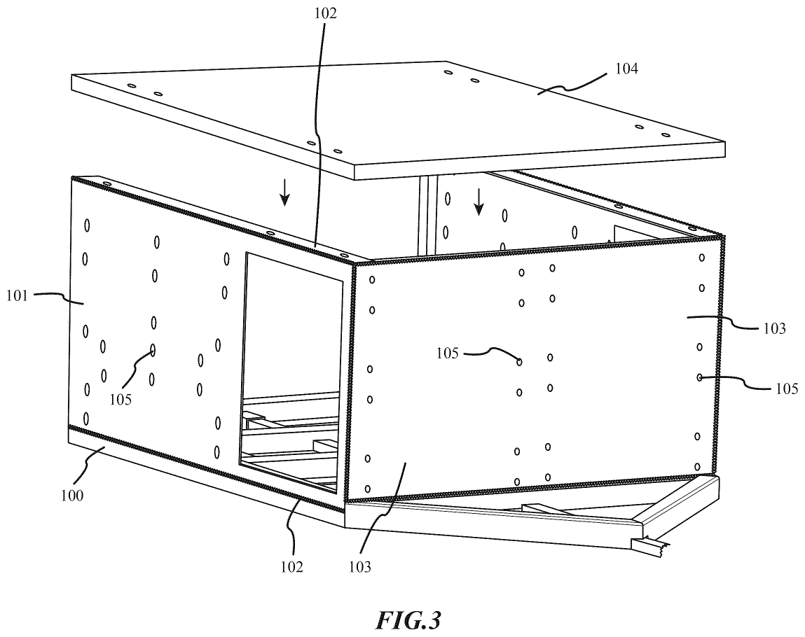

FIG. 4 depicts a perspective view of aspects of the frame component in an embodiment of the trailer.

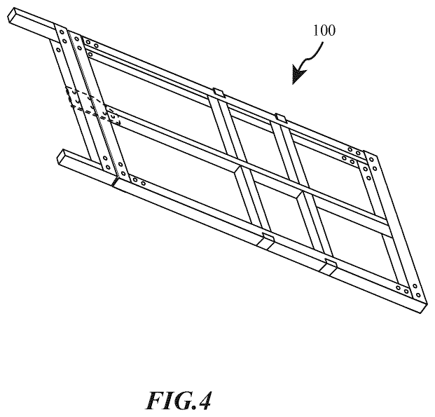

FIG. 5 depicts a perspective view of a side panel in an embodiment of the trailer.

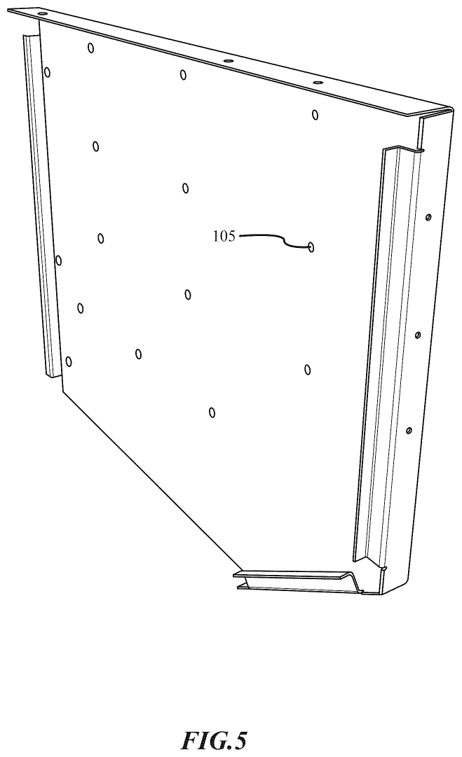

FIG. 6 depicts a perspective view of the side and front panels attached to the frame in an embodiment of the trailer.

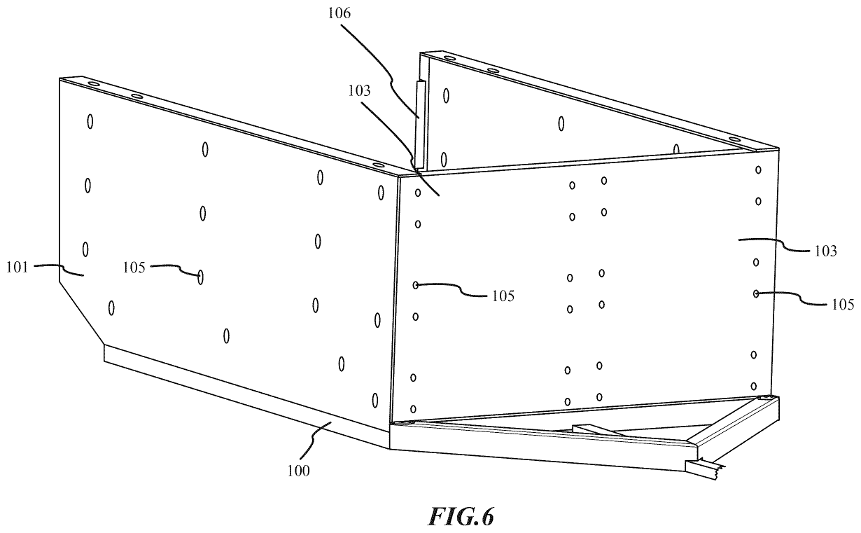

FIG. 7 depicts a cross-sectional view of a frame rail component of an embodiment of the trailer.

FIG. 8 depicts a view of a lower side panel extension in an embodiment of the trailer.

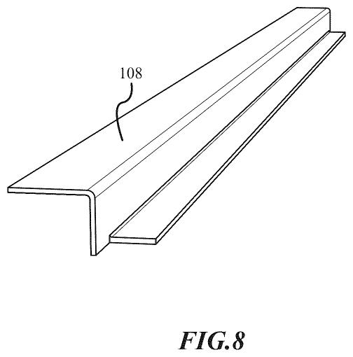

FIG. 9 depicts a perspective view of the side and front panels further comprising a door attached to the frame in an embodiment of the trailer.

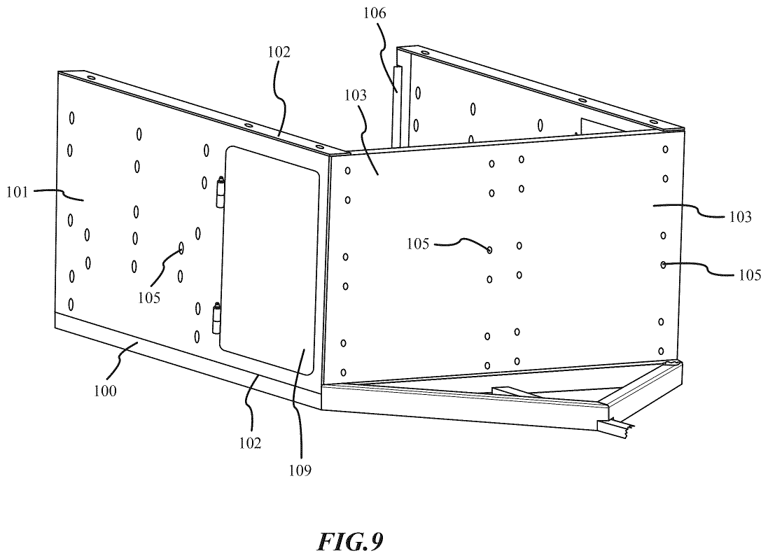

FIG. 10 depicts aspects of the trailer related to the attachment location of the door and welding points of the front panel and side panel extension in an embodiment of the invention.

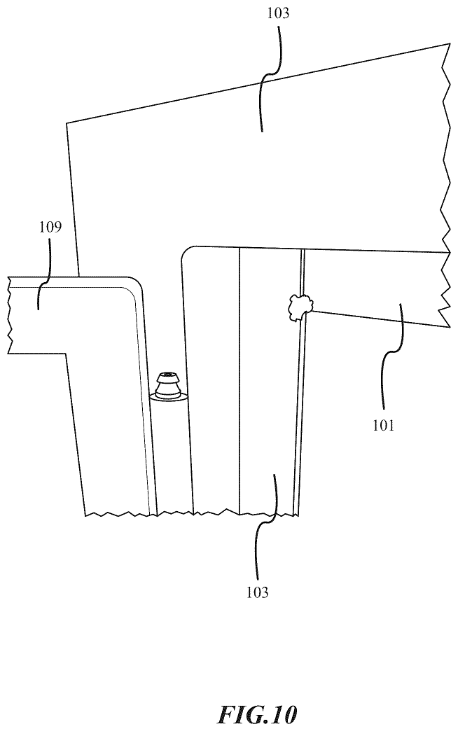

### DETAILED DESCRIPTION

Embodiments of the invention relate to an innovative design and manufacturing process for vehicular tow-behind trailers. This embodiment addresses several key challenges in traditional trailer construction by utilizing a novel approach that emphasizes simplicity, efficiency, and precision in manufacturing.

At the core of embodiments is the primary use of 4 foot by 8 foot pieces of cold rolled steel as the primary input material for trailer construction. This standardized input allows for a more streamlined and efficient manufacturing process compared to traditional methods that rely heavily on square steel tubing.

The trailer design of an embodiment benefits from precisely engineered components made from 11 gauge rolled steel. These components are crafted using advanced manufacturing techniques, specifically a nitrogen laser cutter and a Computer Numerical Control (CNC) press brake. This combination of standardized input material and precision manufacturing equipment allows for the creation of highly accurate and consistent trailer components.

One of the key innovations of this embodiment is the ability to create most, if not all, components of the trailer (primarily excluding connectors such as bolts, nuts, and washers) from the same 4′ by 8′ 11 gauge cold rolled steel sheets. This general uniformity in material input dramatically simplifies the manufacturing process and results in precisely engineered output components that significantly ease the assembly process.

The manufacturing process in accordance with an embodiment begins with the use of a nitrogen laser cutter, which can achieve tolerances as precise as 3 thousandths of an inch. This laser cutter is used to cut the 4′ by 8′ steel sheets into the required shapes for various trailer components. The laser cutter also creates precise holes in these components, which serve as attachment points for accessories such as molly panels, fenders, racks, and roof towers.

Following the laser cutting process, a CNC press brake is used to bend the cut steel sheets into the required shapes. The press brake is programmed to perform specific bends, ensuring consistency and precision in the shaping of each component. This process allows for the creation of complex shapes and structures that would be difficult or impossible to achieve with traditional manufacturing methods.

This innovative approach to trailer design and manufacturing results in a product that is easier to manufacture, lighter in weight, and quicker to assemble compared to traditional trailer designs. This embodiment represents a shift from fabricated design to engineered design, leveraging computer-aided design (CAD) and precision manufacturing equipment to create a more efficient and cost-effective product.

An embodiment of the invention comprises several key components that work together to create an innovative and efficient trailer design. These components include the side panels (passenger panel), front panel, extended side panel bottom and top, rear panel top trim piece, side door, optional top protrusions (“towers”), roof, and lower frame. The design also incorporates specific material specifications, primarily utilizing 11 gauge cold rolled steel, and employs a unique manufacturing process involving a nitrogen laser cutter and CNC press brake. This embodiment allows for two distinct trailer models with shared components and design principles. The integration of these elements results in a trailer that is easier to manufacture, lighter in weight, and quicker to assemble compared to traditional designs, while also offering improved shipping capabilities through its modular construction.

An embodiment of the invention includes side panels, also referred to as passenger panels or driver panels (referring to the side of the vehicle upon which they are placed), which are key structural components of the trailer. These panels are constructed from 4′ by 8′ pieces of 11 gauge (⅛″) cold rolled mild steel, precisely cut and shaped using a nitrogen laser cutter and CNC press brake. In an embodiment, the panels are approximately 48 inches wide by 34 inches tall.

The side panels are positioned posterior to the door on the side of the trailer during construction. They feature a hole pattern in an embodiment that allows for the mounting of accessories, such as molly panels, on the side of the trailer. This design element provides flexibility for customization and additional functionality.

The side panels incorporate flanges that accommodate the door opening and the ceiling of the door. These flanges are integral to the structural integrity of the trailer and contribute to its overall strength and stability.

One of the most significant aspects of the side panel design is its structural importance. Unlike traditional trailer designs that rely on a fabricated frame, these side panels serve as the primary structural elements of the trailer body. This innovative approach eliminates the need for a separate frame, significantly reducing the complexity of the manufacturing process.

The choice of 11 gauge (⅛″) cold rolled mild steel for the side panels offers several key benefits that enhance the structural integrity and manufacturing efficiency of the trailer. This specific material selection allows for an optimal balance between strength and manufacturability in the context of the side panels. The 11 gauge thickness provides sufficient strength to serve as the primary structural element of the trailer body, eliminating the need for a separate frame, while still being thin enough to be easily manipulated by the CNC press brake.

The use of this particular steel gauge enables precise bending without compromising the structural integrity of the panels. Thicker gauges, such as 3/16″ thickness, while potentially stronger, would require more rounded corners during bending, resulting in looser tolerances and potentially compromising the trailer's overall design precision. Conversely, thinner gauges would not provide adequate strength for the structural requirements of the side panels. The 11 gauge steel strikes the ideal balance, allowing for sharp, precise bends while maintaining the necessary structural strength. This material choice contributes significantly to the trailer's overall lightweight design and the efficiency of the manufacturing process, further reducing production time and costs.

The present inventor has recognized that structural nature of the side panels in the context of the preferred embodiment has a dramatic impact on the build time of the trailer. By incorporating the structural elements into the side panels, the overall build time is reduced from approximately 12 hours to about 2 hours. This substantial reduction in assembly time is primarily due to the elimination of the need to fabricate and weld a separate frame together.

The side panels are designed to mesh perfectly with other components such as the front panel and extended side panel bottom, ensuring repeatable dimensions and flush fitting. This precision is achieved through the use of the laser cutter, which cuts out the precise shape of the panels, including relief cuts where necessary. The CNC press brake then receives programmatic instructions to perform specific bends, creating the required shapes with high accuracy.

This innovative design and manufacturing approach for the side panels contributes significantly to the overall efficiency, lightweight nature, and ease of assembly of the trailer, addressing many of the challenges associated with traditional trailer construction methods.

An embodiment of the invention includes extended side panel bottom and top components, which are integral parts of the trailer's structure. These components are designed to complement the main side panels and enhance the overall functionality and structural integrity of the trailer.

The extended side panel bottom is positioned under the door in the trailer's construction. Its primary function is to provide additional structural support and to create a seamless transition between the side panels and the trailer's floor. The extended side panel top, conversely, is positioned over the door in the construction. Its purpose is to provide custom dimensions that allow it to mesh perfectly with other components, particularly in relation to the trim pieces.

Both the extended side panel bottom and top are designed to integrate seamlessly with other components of the trailer. Their geometry in an embodiment is precisely engineered to mesh perfectly with the side panels and front panel, ensuring repeatable dimensions and a flush fit. This precision in design and manufacturing contributes significantly to the overall structural integrity and aesthetic appeal of the trailer.

In an embodiment of the invention, the extended side panel bottom and top are specifically designed to frame and accommodate a side door placed between them. The extended side panel bottom is positioned under the door opening, while the extended side panel top is situated above it. This configuration creates a precise frame for the side door, ensuring a secure and well-fitted installation.

The geometry of these extended panels is engineered in an embodiment to not only integrate with the side panels and front panel but also to create an exact opening for the side door. The dimensions of the extended panels are calculated to match the specifications of the side door, which is sourced from a third-party manufacturer. This precise sizing ensures that the door fits snugly within the frame created by the extended panels, maintaining the trailer's structural integrity and weatherproofing.

The use of one-piece top and bottom side panels in an embodiment allows for the integration of door-seal without any additional fabrication. This design feature simplifies the manufacturing process and enhances the overall efficiency of the trailer construction. The seamless integration of the door-seal into the one-piece panels contributes to improved weatherproofing and structural integrity of the door frame.

Furthermore, the one-piece top and bottom panels in an embodiment are manufactured to specific lengths to accommodate different door dimensions. This flexibility in manufacturing allows for customization of the trailer design to meet various user needs and preferences. The ability to adjust panel lengths during the manufacturing process, rather than through additional fabrication steps, aligns with the overall design philosophy of the invention, which emphasizes efficiency and precision in manufacturing.

The laser cutting process used in manufacturing these extended panels in an embodiment allows for the creation of precise attachment points and alignment features specifically designed for the side door installation. These may include pre-cut holes or slots for hinges, latches, and seals, further streamlining the assembly process and ensuring consistent door placement across all manufactured units. The CNC press brake is then used to create any necessary bends or flanges that contribute to the door frame structure, providing additional support and ensuring a flush fit with the installed door.

The geometry of these extended panels in an embodiment is carefully engineered to not only integrate with the side panels and front panel but also to create an exact opening for the side door. The dimensions of the extended panels are calculated to match the specifications of the side door, which is sourced from a third-party manufacturer. This precise sizing ensures that the door fits snugly within the frame created by the extended panels, maintaining the trailer's structural integrity and weatherproofing.

The laser cutting process used in manufacturing these extended panels in an embodiment allows for the creation of precise attachment points and alignment features specifically designed for the side door installation. These may include pre-cut holes or slots for hinges, latches, and seals, further streamlining the assembly process and ensuring consistent door placement across all manufactured units. The CNC press brake is then used to create any necessary bends or flanges that contribute to the door frame structure, providing additional support and ensuring a flush fit with the installed door.

In an embodiment, generally the design of the parts comprising this invention was made with a detailed understanding of CNC press brake limitations and capabilities. This knowledge is crucial for achieving the high level of precision and consistency required in the manufacturing process. Only high-quality and superiorly accurate CNC press brakes can accomplish these bend sequences to the required accuracy.

The use of CNC press brakes in an embodiment is essential for executing the complex bending operations needed to form the trailer components from flat steel sheets into their final three-dimensional shapes. These machines are programmed to perform specific bends with extreme precision, ensuring that each component meets the exact specifications required for the modular assembly of the trailer.

The design in such embodiment takes into account the capabilities of these high-end CNC press brakes, including their ability to make multiple bends in a single setup, maintain consistent bend angles across long lengths, and achieve tight tolerances in the bent parts. This consideration of manufacturing capabilities in the design phase contributes significantly to the overall efficiency and precision of the trailer production process. The accuracy of the CNC press brakes is particularly critical in an embodiment for components such as the extended side panels, which must integrate seamlessly with other parts of the trailer structure. The precise bends created by these machines ensure that the door frame structure is perfectly aligned, contributing to the overall structural integrity and weatherproofing of the trailer.

The integration of these components with others is facilitated by the manufacturing process employed in this embodiment. Like many of the other components, the extended side panels are cut from 4′ by 8′ sheets of 11 gauge cold rolled steel using a nitrogen laser cutter. This process allows for highly precise cuts, including any necessary relief cuts, which are crucial for achieving the perfect fit with other components.

Following the cutting process, the CNC press brake is used to bend these components into their required shapes. The press brake receives programmatic instructions to perform specific bends, ensuring consistency and accuracy in the shaping process. This precision in manufacturing allows the extended side panels to fit perfectly with the side panels, front panel, and other components, creating a robust and well-integrated structure.

The extended side panel top, in particular, plays a crucial role in the trailer's structure. It is welded to two trim pieces per side, providing additional structural support. The anterior aspect of the extended side panel top is welded to the front panel, further enhancing the overall rigidity and strength of the trailer body.

By incorporating these extended side panels, this embodiment of the invention achieves a more streamlined and efficient design. These components contribute to the trailer's structural integrity while also simplifying the assembly process, thereby reducing manufacturing time and costs compared to traditional trailer designs.

An embodiment of the invention incorporates a side door as part of the trailer design. The side door is a unique component in accordance with an embodiment, that it capable of being sourced from a third-party manufacturer providing efficiency and flexibility, rather than being fabricated in-house from the steel inputs like many of the other trailer components.

The integration of the manufactured side door is facilitated by the precise design of other trailer components, particularly the extended side panel bottom and top. These components in an embodiment are specifically engineered to frame the side door opening, ensuring a proper fit for the sourced door. The extended side panels in an embodiment when further framed by a front panel and side panel create an precise opening that matches the specifications of each side door, allowing for seamless integration into the overall trailer structure.

While the door itself is a standardized design and optionally sourced externally as opposed to being manufactured with the other parts of the trailer from 4′ by 8′ steel sheets in accordance with an embodiment, the trailer design incorporates features to ensure its proper installation and functionality. This may include precisely cut attachment points for hinges, latches, and seals, created during the manufacturing process of the surrounding panels. These features, achieved through the use of the nitrogen laser cutter and CNC press brake, ensure consistent and accurate door placement across all manufactured units, despite the door itself being sourced from a third party.

This approach of combining in-house manufactured structural components with a sourced side door exemplifies the design philosophy of the invention, which aims to balance manufacturing efficiency with functional quality. By sourcing a specialized component like the door while maintaining precise control over its integration points, the overall design achieves both manufacturing simplicity and high-quality functionality.

Embodiments of the invention further comprise a front panel, which serves as a crucial structural component of the trailer. The front panel is constructed from a 4′ by 8′ piece of 11 gauge (⅛″) cold rolled mild steel, precisely cut and shaped using a nitrogen laser cutter and CNC press brake.

The front panel is configured in an embodiment to be welded to both the top and bottom side trim pieces during the construction process. This welding creates an integral connection with the trim pieces, effectively forming a complete box structure for the trailer body. The welding of the front panel to these trim pieces significantly reduces the number of welds required during construction, thereby decreasing the overall build time and cost.

The welding process in this embodiment represents a significant simplification compared to traditional fabricated box-style trailers. In conventional manufacturing techniques, trailer construction often involves numerous welds to join multiple frame components, side panels, and structural elements. This embodiment, however, leverages the innovative design of the front panel and its integration with the side trim pieces to drastically reduce the number of welds required.

By utilizing the front panel as a key structural component that connects directly to the top and bottom side trim pieces, this design eliminates the need for multiple intermediate welds typically found in traditional trailer construction. The front panel effectively becomes part of the trailer's structural frame, reducing the complexity of the welding process. This streamlined approach not only decreases the overall number of welds but also simplifies the welding procedure, as the welds are concentrated at specific, easily accessible points where the front panel meets the trim pieces. As a result, the welding process becomes more efficient, requiring less time and skilled labor compared to the extensive welding needed in traditional fabricated box-style trailers. This efficiency in welding contributes significantly to the overall reduction in manufacturing time and cost, while still maintaining the structural integrity and durability of the trailer.

A key feature of the front panel is its flange on the top, which serves as a support for the roof. This flange allows the roof to sit securely on the front panel while providing additional weld surface area to the side trim piece. Importantly, the front panel is not welded directly to the roof, allowing the roof to remain removable from the body for potential future customizations or maintenance.

The dimensions of the front panel are precisely engineered to fit the trailer design in accordance with an embodiment. It measures 48.25 inches wide by approximately 28 inches in height or approximately 38 inches in height in varying embodiments, ensuring a perfect fit with the side panels and other components of the trailer.

To enhance the versatility and customization options of the trailer, the front panel incorporates a plurality of holes. These pre-cut holes serve as mounting points for various accessories, allowing users to add front-mounted equipment or customize the trailer's functionality as needed. The precise positioning and sizing of these holes are achieved through the use of the nitrogen laser cutter, ensuring consistency and accuracy across all manufactured units.

The use of 11 gauge cold rolled mild steel for the front panel, consistent with other major components of the trailer, provides an optimal balance between strength and manufacturability. This material choice allows for precise cutting and bending while maintaining the structural integrity necessary for the panel's role in the trailer's overall design.

An embodiment of the invention includes a rear panel top trim piece, which serves as a crucial structural and finishing element at the top rear of the trailer body. This component is manufactured from 4′by 8′sheets of 11 gauge cold rolled steel, consistent with other major components of the trailer design. The rear panel top trim piece is precisely cut and shaped using a nitrogen laser cutter and CNC press brake, ensuring high accuracy and consistency in production.

The rear panel top trim piece is designed to integrate seamlessly with the side panels and roof of the trailer. It likely incorporates flanges or specific attachment points that allow for secure fastening to adjacent components, thereby contributing to the overall structural integrity of the trailer body. The precise cutting capabilities of the nitrogen laser cutter enable the creation of any necessary holes or cutouts for optimal integration with other trailer components.

One notable aspect of the rear panel top trim piece is its standardization across different trailer models within this design. This standardization contributes significantly to manufacturing efficiency by allowing the same component to be used in multiple trailer configurations. By utilizing a common rear panel top trim piece across different models, the manufacturing process is streamlined, potentially reducing inventory complexity and production costs.

The use of 11 gauge cold rolled steel for the rear panel top trim piece, consistent with other trailer components, provides an optimal balance between strength and manufacturability. This material choice allows for precise cutting and bending while maintaining the structural integrity necessary for the component's role in the trailer's overall design.

The rear panel top trim piece, along with other standardized components, aligns with the overall design philosophy of the invention, which emphasizes simplicity, efficiency, and precision in manufacturing. This approach to component design and production contributes to the overall goal of creating a trailer that is easier to manufacture, lighter in weight, and quicker to assemble compared to traditional designs.

Embodiments of the invention further comprise a roof. The roof component in an embodiment of the invention is designed with specific features to enhance the trailer's functionality and ease of assembly. The roof in accordance with the preferred embodiment is constructed as a removable element, allowing for future interior customizations, use cases requiring carrying of materials above the roof line, or maintenance as needed.

Embodiments of the invention comprise distinct models that share many common components and manufacturing processes while differing in size and configuration to meet varying user needs. A larger model is characterized by its increased length and height compared to a smaller model in accordance with embodiments. A key distinguishing feature of the larger model is its dual rear door configuration. The lower rear door is designed with a downward slope towards the anterior of the trailer. This slanted design serves a practical purpose, providing an improved departure angle when traversing rough terrain. The angled lower door reduces the likelihood of the rear aspect of the trailer making contact with the ground or obstacles during off-road use.

In contrast, the smaller model in an embodiment features a more compact design, likely with a single rear door configuration, though this is not explicitly stated in the provided information. Despite these differences, both models share several common components and design principles. Construction materials for both models primarily utilize 11 gauge (⅛″) cold rolled mild steel for most components, with some variations for specific parts like doors and roofs. The manufacturing process benefits from the same innovative approach, using a nitrogen laser cutter for precise cutting and hole creation, and a CNC press brake for bending components.

Both larger and smaller models in embodiments incorporate side panels as a key structural element, which contribute significantly to reducing the overall build time of the trailers. The models in accordance with an embodiment share the same or similar top and bottom rear trim pieces, as well as side trim pieces that connect the side panels to the front panels. The roof design in various embodiments features a removable roof, allowing for interior customization. The roof is designed as a large pan-like structure with a flange around its perimeter. This flange is a crucial design element that enables the roof to integrate seamlessly with the side pieces of the trailer. During assembly, the roof's flange slides over the side pieces and down, effectively capping the entire structure. In two exemplary embodiments, the roof dimensions are 48.5″ Wide×65.290″ Long and 48.5″ Wide×76.084″ Long, allowing for precise fitting of the roof to different trailer sizes while maintaining a consistent width.

Both larger and smaller models in embodiments are designed with pre-cut holes and attachment points for various accessories, such as roof racks, molly panels, and side rack panels. The frame design incorporates a similar modular approach in both models, including the innovative approach to the tongue attachment for improved shipping efficiency. The shared components and manufacturing processes between the two models contribute to manufacturing efficiency and cost-effectiveness, while the differences in size and configuration allow the invention to cater to a broader range of user needs and applications.

The removability of the roof is a key feature of this design in accordance with an embodiment. It allows for easy access to the interior of the trailer, facilitating potential modifications or customizations after initial assembly. This feature provides flexibility for users who may want to adapt the trailer's interior to suit different needs over time.

The roof's construction also incorporates specific features to enhance the trailer's structural integrity and functionality. The roof includes holes that align with corresponding holes in the flanges of the side panels. This alignment allows for the installation of optional top protrusions or “towers” that can be used for mounting accessories or roof racks. As such, an embodiment of the invention thus includes these optional top protrusions, also referred to as “towers,” which can be installed on the trailer to provide mounting points for accessories or roof racks. These towers are designed to interface with aligned holes in the side panels, roof, and internal structural components of the trailer.

The roof is designed to work in conjunction with an adjustable roof rack system. The holes in the roof allow for the installation of a base for this system, enabling users to add and adjust roof racks as needed. Thus, the towers are engineered to be securely attached through a series of aligned holes in the roof. Specifically, in an embodiment holes in the top of the side panels align with corresponding holes in the roof and internal H-braces. This alignment creates a robust connection point that extends from the side panels through the roof structure.

The design of these towers allows for the installation of an adjustable roof rack system. The base of the towers can accommodate a roof rack that is capable of sliding up and down via attachment points located within the vertical aspects of the towers in an embodiment, providing flexibility in positioning and use. This adjustability feature enhances the versatility of the trailer, allowing users to customize the configuration of roof-mounted accessories based on their specific needs.

The integration of the towers with the trailer's structure is further enhanced by the inclusion of H-braces installed beneath the roof. These H-braces contain holes that align with those in the roof and the flanges of the side panels in an embodiment. This multi-component alignment (roof, side panels, and H-braces) creates an integrated and structurally sound mounting system for the towers and any attached accessories or roof racks.

Beneath the roof in accordance with various embodiments, H-braces are installed provide additional rigidity to the structure of the trailer. These H-braces in an embodiment further comprise holes that align with the holes in the roof and the flanges of the side panels, creating a robust connection point for accessories or structural reinforcement.

The roof in an embodiment comprises 12 gauge metal, which is slightly thinner than the 11 gauge used for most other components of the trailer. This choice of material allows for easier bending and shaping of the roof's radius, along with reduced weight at the upper portions of the trailer, without compromising its structural integrity.

The trailer further comprises a lower frame in accordance with various embodiments. The lower frame of the trailer in an embodiment of the invention is primarily constructed from 4′ by 8′sheets of steel, consistent with the manufacturing approach used for other components. This design choice contributes to the overall goal of simplifying inputs and streamlining the manufacturing process.

The lower frame of the trailer, including its key structural components such as rails or bars, is constructed from 4′ by 8′ sheets of 11 gauge cold rolled steel as inputs, consistent with the manufacturing approach used for other trailer components. This design choice aligns with the invention's overall goal of simplifying inputs and streamlining the manufacturing process.

The construction process for these frame components involves bending the 4′ by 8′ steel sheets using a CNC press brake in accordance with a preferred embodiment. This machine is programmed to create precise bends in the steel, shaping it into the desired structural forms for the frame. The use of a CNC press brake ensures consistency and accuracy in the bending process, which is crucial for maintaining the structural integrity and assembly precision of the trailer.

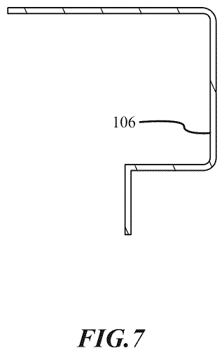

The resulting cross-sectional shape of the rails of the frame, as depicted by FIG. 7 in an embodiment. Various embodiments of the cross-sectional shape comprise a variation of a C-channel or box section, in accordance with various embodiments. These shapes are commonly used in trailer frames due to their strength and rigidity. The exact cross-sectional shape in accordance with an intended method of manufacture is determined by the programmed bending sequence in the CNC press brake.

For example, a C-channel cross-section might be achieved by making two parallel bends along the length of the steel sheet, creating a shape that resembles the letter “C” when viewed from the end. Alternatively, a box section could be formed by making four bends to create a closed, rectangular cross-section. In accordance with the preferred embodiment, the rails of the frame comprise a C-channel cross-section as depicted in FIG. 7.

The present inventor has recognized that in accordance with the preferred embodiment, the specific use of 11 gauge steel for these components is critical as it provides an optimal balance between strength and manufacturability. This thickness allows for precise cutting and bending while maintaining the structural integrity necessary for the frame's role in supporting the trailer.

In an embodiment, the frame design includes features that enhance its functionality and ease of assembly. For instance, the front rails incorporate cutouts that allow for the insertion of 2″ square tubing running along the central axis of the frame from front to back or from back to front, which in an embodiment is included in the design and runs the length of the trailer. This design enables the use of modular components, contributing to the “click-together” assembly concept that characterizes the overall trailer design.

This approach to constructing the lower frame components from bent steel sheets, rather than using pre-formed tubing or multiple welded pieces, aligns with the invention's focus on efficiency in manufacturing, reduced weight, and ease of assembly, while maintaining the necessary structural integrity for a trailer.

The lower frame comprises several key components, including side rails and front rails, in accordance with an embodiment manufactured from bent steel sheets as described elsewhere herein. These components in accordance with an embodiment are custom-engineered parts that contribute to the “click-together” welded trailer box design, which is intended to reduce weight, facilitate easy assembly, and decrease manufacturing time.

The front rail of the frame in an embodiment mirrors the back rail in design. This symmetry represents a departure from traditional trailer designs that typically use two-inch tubing and require precise alignment. Instead, this embodiment incorporates a modular frame rail design that offers several advantages:

The front rails feature a centrally located cutout that allows for the insertion of a 2″ square tube on the inside, running the length of the trailer. This design enables the use of one continuous 10′ long piece of 2″ square tube for the main connection point, extending from the front to the back of the trailer.

In addition to the main 10′ long 2″ square tube centrally located through the length of the trailer, in an embodiment the design incorporates four side-inserted 2″ pieces of tube, each 23″ long. These side tubes are placed and then welded to the main centrally located tube, creating a robust and integrated frame structure. In total, in accordance with an embodiment the frame utilizes five pieces of 2″ tube.

This modular frame rail design offers a significant advantage in terms of shipping and transportation. The tongue of the trailer, which extends beyond the box, can be removed. This feature allows the trailer to be shipped on a more compact 48″×68″ pallet instead of a 10′pallet, resulting in reduced shipping costs.

The frame design of the trailer in an embodiment incorporates features that facilitate compact shipping, reducing transportation costs and improving logistics efficiency. A key element of this design is the removable tongue, which allows for a significant reduction in the overall shipping dimensions of the trailer.

The tongue of the trailer, which typically extends beyond the main box structure in the fully assembled and constructed state, is designed to be detachable in accordance with an embodiment. This removable tongue feature enables the trailer to be shipped on a more compact 48″×68″ pallet, as opposed to a larger 10′ pallet that would be required if the tongue were permanently affixed. This reduction in shipping size translates directly to lower shipping costs and easier handling during transportation.

The attachment method of the removable tongue to the main body of the trailer is engineered for both security and ease of assembly. The frame design incorporates holes facing the posterior (rear) of the trailer, specifically designed for attaching the tongue. These attachment points ensure a secure connection between the tongue and the main trailer body when assembled.

The frame design of the trailer in an embodiment incorporates features that facilitate compact shipping, reducing transportation costs and improving logistics efficiency. A key element of this design is the removable tongue, which allows for a significant reduction in the overall shipping dimensions of the trailer.

The tongue of the trailer, which in an embodiment extends beyond the main box structure in the fully assembled and constructed state, is designed to be detachable. This removable tongue feature enables the trailer to be shipped on a more compact 48″×68″ pallet, as opposed to a larger 10′ pallet that would be required if the tongue were permanently affixed. This reduction in shipping size translates directly to lower shipping costs and easier handling during transportation.

The attachment method of the removable tongue to the main body of the trailer in an embodiment is engineered for both security and ease of assembly. The frame design incorporates holes facing the posterior (rear) of the trailer, specifically designed for attaching the tongue. These attachment points ensure a secure connection between the tongue and the main trailer body when assembled.

Expanding on this design, holes are precisely lasered into each front and side frame rail in an embodiment. When assembled, these holes correspond with the holes lasered into a single plate. This plate, when fastened with bolts, rigidly connects the tongue of the trailer with the main frame, providing a secure and stable attachment point.

Additionally, six lasered holes are added to each front rail, allowing for bolts to secure the tongue to the frame in an embodiment. This provides an extra layer of security and stability to the tongue attachment. To maintain an integral 2″ square tube running the length of the trailer, a 2″ receiver hitch is welded in place just behind the front frame rail. This 2″ ID receiver accepts the protruding 10″ section of square tube from the tongue assembly. Once inserted, the tube from the tongue assembly is pinned in place with a standard hitch pin. This design allows for the continuous 2″ square tube that runs the length of the trailer, which is a key feature of the frame design.

In total, in an embodiment there are three mechanical methods to secure the tongue to the frame:
1. The bolted plate connecting the tongue to the main frame
2. The bolts securing the tongue to the front rails
3. The pinned 2″ square tube inserted into the receiver hitch
   This multi-method attachment system allows for quick removal of the tongue for shipping or storage while maintaining structural integrity when assembled.

Pivotal to all of these design features is the use of 11 gauge cold rolled steel in embodiments, which is precisely lasered and bent via a CNC press brake. This manufacturing process ensures the high precision and consistency required for the modular design of the trailer, particularly for the critical attachment points of the removable tongue.

The overall design of the parts comprising an embodiment of the invention was made with a detailed understanding of CNC press brake limitations and capabilities. Only high-quality and superiorly accurate CNC press brakes can accomplish these bend sequences to the required accuracy, which is crucial for achieving the high level of precision and consistency required in the manufacturing process, especially for components like the frame rails and tongue attachment points.

This innovative approach to the frame design, with its removable tongue and reinforced attachment points, exemplifies embodiments of the invention and the associated focus on manufacturing efficiency and practical functionality. It allows for more cost-effective shipping and transportation of the trailer units while maintaining the structural integrity necessary for safe and reliable use once assembled.

This modular approach to the frame design, with its removable tongue and reinforced attachment points, exemplifies the invention's focus on manufacturing efficiency and practical functionality. It allows for more cost-effective shipping and transportation of the trailer units while maintaining the structural integrity necessary for safe and reliable use once assembled.

The ability to ship the trailer on a smaller pallet not only reduces direct shipping costs but also potentially allows for more units to be transported simultaneously, further enhancing logistical efficiency. This feature aligns with the overall design philosophy of the invention, which emphasizes efficiency in both manufacturing and practical use aspects of the trailer.

To facilitate the removable tongue design, the frame includes holes facing the posterior for attachment to the tongue, as well as plates that provide additional rigidity to compensate for the two-piece design.

This approach to the lower frame design, with its modular components and use of standard steel sheets, aligns with the overall invention's focus on efficiency in manufacturing, reduced weight, and ease of assembly, while maintaining the necessary structural integrity for a trailer.

The front panel, side panel, and rear panel components of the trailer are connected in an embodiment through a welding process that contributes to the overall structural integrity and manufacturing efficiency of the design. The standardized welding approach aligns with the invention's goal of simplifying assembly and reducing production time.

The front panel in an embodiment is configured to be welded to both the top and bottom side trim pieces during the construction process. This welding creates an integral connection with the trim pieces, effectively forming a complete box structure for the trailer body. By welding the front panel to these trim pieces, the number of welds required during construction is significantly reduced, thereby decreasing the overall build time and cost.

The side panels in an embodiment are welded to the front panel and rear panel at their respective junctions. The side panels are designed with flanges that can accommodate the door opening and the ceiling of the door, which suggests that these flanges provide welding surfaces for connecting to the front and rear panels.

The rear panel design in an embodiment represents a significant innovation that eliminates the need for a traditional rear panel. Instead, the design utilizes uniquely bent flanges on the rear of each passenger and driver side panel to form the vertical door frames for the rear door.

These bent flanges on each side panel are precisely cut and bent using CNC laser and press-brake technology. The design is further enhanced by adding a single top z-shaped flange horizontally to both the top and bottom of the rear opening. Once welded in place, these components create a rigid door frame that provides the exact dimensions required for the rear door while also incorporating the necessary flanges for the door seal. This innovative approach allows for the entire trailer body, mechanical structure, and required door frame to be constructed from single sheets of 11 gauge cold-rolled steel. The use of advanced CNC laser cutting and press-brake technology enables the creation of complex shapes and precise bends that would be difficult or impossible to achieve with traditional manufacturing methods. The design significantly simplifies the manufacturing process and reduces the number of inputs required. In contrast to traditional trailer designs that typically require multiple components such as square tubing, angle iron, and various fasteners to create a rear door frame, this approach achieves the same result with a more streamlined and efficient process.

This rear panel design in an embodiment aligns with the overall philosophy of the invention, which emphasizes manufacturing efficiency, reduced weight, and ease of assembly. By integrating the rear door frame into the side panels and utilizing precision manufacturing techniques, the design achieves a high level of structural integrity while minimizing the number of components and assembly steps required.

The welding process in this design embodiment represents a significant simplification compared to traditional fabricated box-style trailers. By utilizing the front panel and likely the rear panel as key structural components that connect directly to the side trim pieces and side panels, this design eliminates the need for multiple intermediate welds typically found in traditional trailer construction in accordance with embodiments. The panels effectively become part of the trailer's structural frame, reducing the complexity of the welding process.

This streamlined approach concentrates the welds at specific, easily accessible points where the panels meet the trim pieces and each other. This precision in component manufacturing contributes to more accurate fit-up during assembly, potentially further simplifying the welding process and improving weld quality. As a result, the welding process becomes more efficient, requiring less time and skilled labor compared to the extensive welding needed in traditional fabricated box-style trailers. This efficiency in welding contributes significantly to the overall reduction in manufacturing time and cost, while still maintaining the structural integrity and durability of the trailer in accordance with embodiments.

Embodiments of the invention primarily utilize 11 gauge (⅛″) cold rolled mild steel for most components of the trailer. This specific material choice is integral to the design and manufacturing process of the trailer, offering several advantages. The 11 gauge steel provides an ideal balance between strength and manufacturability, allowing for precise cutting and bending while maintaining the structural integrity necessary for the trailer's components. This thickness is particularly suitable for the bending processes employed in the trailer's construction, allowing for sharp, precise bends without the risk of material failure or excessive deformation. Thicker gauges, such as 3/16″, could still be bent but would require more rounded corners, resulting in looser tolerances and potentially compromising the design's precision.

The use of 11 gauge steel in accordance with aspects of embodiments of the invention aligns with the focus on manufacturing efficiency in embodiments of the invention. It can be easily cut using a nitrogen laser cutter and shaped using a CNC press brake, allowing for the creation of precisely engineered components from standard 4′ by 8′ steel sheets. This contributes to the goal of creating a lighter trailer compared to traditional designs while offering sufficient strength for the trailer's structural requirements.

The rationale for choosing 11 gauge steel in accordance with aspects of embodiments extends beyond its physical properties. It represents a carefully considered compromise between various factors. Thicker gauges would provide more strength but at the cost of increased weight and reduced manufacturability, particularly in terms of achieving precise bends. Thinner gauges would be easier to work with but might not provide the necessary structural strength for a trailer application.

Alternative materials, such as aluminum, were considered in accordance with some embodiments of the invention but ultimately not chosen for the primary structure in embodiments of the invention. To achieve comparable strength to 11 gauge steel, aluminum would need to be significantly thicker, potentially negating the weight savings typically associated with aluminum. Additionally, aluminum presents difficulties in welding, particularly due to its propensity for warping during the welding process. This could compromise the structural integrity and precision of the trailer's components. The use of aluminum would likely require different manufacturing processes and equipment, potentially increasing production complexity and costs.

While the primary structure utilizes 11 gauge steel in accordance with the preferred embodiment, embodiments of the invention incorporate some variations in material thickness for specific components. For example, the side doors in an embodiment use 14 gauge steel, likely due to different strength requirements or manufacturing considerations for these components. The roof is constructed from 12 gauge metal, which is slightly thinner than the main body components. This choice allows for easier bending and shaping of the roof's radius without compromising its structural integrity.

These material specifications and choices reflect the overall design philosophy in embodiments of the invention, which emphasizes manufacturing efficiency, structural integrity, and practical functionality in a lightweight, easily assembled trailer design. The use of 11 gauge steel for most components in accordance with an embodiment, with strategic variations for specific parts, allows for the creation of a trailer that balances strength, weight, and manufacturability in a way that aligns with the goals of simplifying production and improving overall efficiency.

The manufacturing process in accordance with embodiments of the invention comprises several steps, including the following:

Preparing the raw materials, including the accumulation of 4′ by 8′ sheets of 11 gauge cold rolled steel as the primary input. This initial step is crucial for the efficiency and consistency of the manufacturing process. The choice of 11 gauge (⅛″) cold rolled mild steel provides an optimal balance between strength and manufacturability. This specific thickness allows for precise cutting and bending while maintaining the structural integrity necessary for the trailer's components. The use of standardized 4′ by 8′ sheets simplifies material handling and inventory management, contributing to overall manufacturing efficiency. Additionally, other materials (such as, for example, 12 gauge steel to form the main body of the roof) may be chosen.

Configuring the nitrogen laser cutter with programmed instructions for cutting precise shapes and creating holes in the steel sheets follows.

The configuration of the nitrogen laser cutter is a critical step that leverages advanced technology to achieve high precision. The laser cutter is programmed to cut with tolerances of 3 thousandths of an inch, ensuring exceptional accuracy in component fabrication. This precision is essential for creating components that will fit together seamlessly during assembly, reducing the need for adjustments or rework later in the process.

Operating the laser cutter to cut out the components of the trailer, including side skins, front skin, and frame pieces, while simultaneously creating holes for attachment points and relief cuts for bending.

During this step, the laser cutter not only cuts the overall shapes of the components but also creates precise holes for attachment points of accessories such as molly panels, fenders, racks, and roof towers. Additionally, the laser makes relief cuts along areas that will undergo difficult bends, preventing shearing off of corners during the subsequent bending process. This multi-functional cutting process significantly reduces the number of separate operations required, enhancing overall efficiency.

Transferring the cut steel components to the CNC press brake for further processing.

This step involves handling of the cut components to maintain their precision and prevent any damage. The transfer process may be automated or manual, depending on the specific manufacturing setup, but in either case, it's designed to maintain the integrity of the cut pieces and prepare them for the bending process.

Programming the CNC press brake with specific bending instructions for each component.

The programming of the CNC press brake in accordance with embodiments is a critical step that translates the design specifications into precise bending instructions. Each component may require multiple bends at specific angles and locations. The programming takes into account the material properties of the 11 gauge steel, ensuring that the bends are executed accurately without compromising the structural integrity of the material. Accordingly, the design of the trailer incorporates specific features to enhance precision and ease of assembly in accordance with embodiments. The programming of the CNC press brake is configured such that flanges on the trailer components are specifically bent to accommodate a 1″ block used during the assembly process. This design feature serves a crucial purpose in ensuring a flush weld with no unevenness between materials. During the assembly process in an embodiment, the 1″ block is applied and clamped between two pieces that are to be welded together. This technique ensures that the welded joint maintains a consistent gap and alignment, contributing to the overall structural integrity and quality of the finished trailer. The side panels of the trailer are designed with pre-cut holes that serve multiple purposes. In addition to their role in mounting accessories, these holes are strategically placed to allow for the attachment of large 90″ squares during assembly. These squares are bolted in place using the pre-cut holes, ensuring that the panels are positioned at exactly 90 degrees during the assembly process. This use of 90″ squares as assembly aids in an embodiment represents an innovative approach to ensuring precision in the trailer's construction. By utilizing these large squares, the manufacturing process can maintain consistent right angles between the side panels and other components, which is crucial for the overall structural integrity and appearance of the trailer.

The incorporation of these assembly techniques in accordance with an embodiment-the use of 1″ blocks for flush welding and 90″ squares for precise panel alignment-further demonstrates the invention's focus on manufacturing efficiency and precision. These methods, combined with the use of CNC laser cutting and press-brake technology for creating the trailer components, contribute to a streamlined assembly process that maintains high standards of accuracy and quality.

Executing the bending process using the CNC press brake to shape the cut steel pieces into their final forms, such as C-channels or box sections for frame components.

During this step, the CNC press brake applies controlled force to create precise bends in the steel components. The use of a CNC press brake ensures consistency across all components, which is essential for the “click-together” assembly concept of the trailer. The bending process transforms flat steel pieces into three-dimensional structural elements, such as C-channels or box sections, which form the core of the trailer's frame and body.

Aligning the bent components using the CNC press brake's backstop to ensure precise geometry.

The backstop feature of the CNC press brake plays a crucial role in maintaining consistent alignment during the bending process. This ensures that each bend is made at the exact same location across multiple components, which is essential for the modular design of the trailer. Precise alignment at this stage facilitates easier assembly and contributes to the overall structural integrity of the finished trailer.

Assembling the major components by welding the front panel to the top and bottom side trim pieces to form the box structure.

This welding step is a critical part of the assembly process, creating the core structure of the trailer. The welding of the front panel to the top and bottom side trim pieces forms a robust box structure that serves as the foundation for the rest of the assembly. This approach significantly reduces the number of welds required compared to traditional fabrication methods, contributing to the overall efficiency of the manufacturing process.

Attaching the side panels to the front and rear panels, utilizing the pre-cut holes for alignment.

The attachment of the side panels is facilitated by the precise holes cut during the laser cutting process. These pre-cut holes ensure accurate alignment of the panels, reducing the time and effort required for assembly. The side panels, or “skins,” play a crucial role in the structural integrity of the trailer, and their proper attachment is essential for the overall strength and durability of the finished product.

Installing additional components such as doors, roof, and optional accessories using the pre-cut holes and attachment points.

This step leverages the precision of the earlier manufacturing stages. The pre-cut holes and attachment points created by the laser cutter allow for easy and accurate installation of doors, the roof, and various optional accessories. This modular approach to assembly enhances the customizability of the trailer while maintaining manufacturing efficiency.

Preparing the lower frame by welding the modular frame rail components. In embodiment, these comprise the main 10′ long 2″ square tube and the four 23″ long side tubes.

The preparation of the lower frame involves welding together the modular frame rail components. This includes welding the main 10′ long 2″ square tube that runs the length of the trailer, along with the four 23″ long side tubes. This modular approach to the frame design contributes to the trailer's structural integrity while also facilitating easier shipping and transportation of the trailer units.

Attaching the removable tongue to the main body of the trailer using the pre-drilled holes and reinforcement plates.

The attachment of the removable tongue is a key feature that enhances the trailer's transportability. The pre-drilled holes ensure precise alignment, while the reinforcement plates provide additional structural support at the connection point. This design allows the trailer to be shipped on a more compact 48″×68″ pallet, reducing shipping costs and improving logistics efficiency.

Conducting quality control checks to ensure all components are properly aligned and securely fastened.

The final step in accordance with an embodiment includes thorough quality control checks to verify that all components are properly aligned and securely fastened. This includes inspecting welds, checking the alignment of panels and accessories, and ensuring that all pre-cut holes and attachment points have been utilized correctly. These quality control measures are essential for ensuring the structural integrity, safety, and functionality of the finished trailer.

Embodiments of the invention comprise distinct trailer models that share many common components and manufacturing processes while differing in size and configuration to meet varying user needs. A larger model in an exemplary embodiment is characterized by its increased length and height compared to the smaller model. A key distinguishing feature of the larger model is its dual rear door configuration. The lower rear door is designed with a downward slope towards the anterior of the trailer. This slanted design serves a practical purpose, providing an improved departure angle when traversing rough terrain. The angled lower door in accordance with such embodiment reduces the likelihood of the rear aspect of the trailer making contact with the ground or obstacles during off-road use.

In contrast, a smaller model in an exemplary embodiment features a more compact design, optionally with a single rear door configuration. Despite these differences, both models share several common components and design principles. Construction materials for both models primarily utilize 11 gauge (⅛″) cold rolled mild steel for most components, with some variations for specific parts like doors and roofs. The manufacturing process benefits from the same innovative approach, using a nitrogen laser cutter for precise cutting and hole creation, and a CNC press brake for bending components.

The distinct models in embodiments comprise side panels as a key structural element, which contribute significantly to reducing the overall build time of the trailers. The models optionally share the same top and bottom rear trim pieces, as well as side trim pieces that connect the side panels to the front panels. The roof design in the distinct models features a removable roof, allowing for interior customization. The roof is described as a large pan with a flange that slides over the side pieces, which may require different configurations to accommodate different dimensions of the distinct models.

The distinct models in embodiments are designed with pre-cut holes and attachment points for various accessories, such as roof racks, molly panels, and side rack panels. The frame design in various embodiments incorporates a similar modular approach in the distinct models, including the innovative approach to the tongue attachment for improved shipping efficiency.

The shared components and manufacturing processes between the distinct models in accordance with various embodiments contribute to manufacturing efficiency and cost-effectiveness, while the differences in size and configuration allow the invention to cater to a broader range of user needs and applications.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

I claim:

1. A vehicular tow-behind trailer comprising:
a frame constructed from 11 gauge cold rolled steel sheets;
a plurality of side panels attached to the frame, wherein the side panels are constructed from 11 gauge cold rolled steel sheets and serve as primary structural elements of the trailer body;
a front panel welded to top and bottom side trim pieces to form a box structure;
a removable roof;
a plurality of pre-cut holes in the side panels and roof for mounting accessories; and
a removable tongue attached to the frame.

2. The trailer of claim 1, further comprising:
a lower frame including side rails and front rails constructed from bent steel sheets;
wherein the front rails include cutouts for inserting a two inch square tube running along a central axis of the frame.

3. The trailer of claim 1, wherein the roof comprises 12 gauge metal and includes a flange around its perimeter that slides over the side panels.

4. The trailer of claim 1, further comprising optional top protrusions configured to interface with aligned holes in the side panels, roof, and internal structural components of the trailer.

5. A method of manufacturing a vehicular tow-behind trailer, the method comprising:
preparing four foot by eight foot sheets of 11 gauge cold rolled steel as primary input material;
configuring a nitrogen laser cutter with programmed instructions for cutting precise shapes and creating holes in the steel sheets;
operating the laser cutter to cut out components of the trailer, including side panels, front panel, and frame pieces, while simultaneously creating holes for attachment points and relief cuts for bending;
transferring the cut steel components to a Computer Numerical Control (CNC) press brake;
programming the CNC press brake with specific bending instructions for each component;
executing the bending process using the CNC press brake to shape the cut steel pieces into their final forms;
aligning the bent components using the CNC press brake's backstop to ensure precise geometry;
assembling the major components by welding the front panel to top and bottom side trim pieces to form a box structure;
attaching the side panels to the front and rear panels;
installing additional components including a removable roof and optional accessories; and
attaching a removable tongue to the main body of the trailer.

6. The method of claim 5, wherein the laser cutter achieves tolerances of three-thousandths of an inch.

7. The method of claim 5, further comprising:
preparing a lower frame by welding modular frame rail components, including a main ten foot long two inch square tube and four twenty three inch long side tubes.

8. The method of claim 5, wherein the removable tongue is attached using pre-drilled holes and reinforcement plates, allowing the trailer to be shipped on a forty eight inch by sixty eight inch pallet.
